(19) United States
(12) Patent Application Publication
(10) Pub. No.: US 2018/0366927 A1
(43) Pub. Date: Dec. 20, 2018

(54) Device Holder

(71) Applicant: Robert Dearinger, Seattle, WA (US)

(72) Inventor: Robert Dearinger, Seattle, WA (US)

(21) Appl. No.: 15/627,914

(22) Filed: Jun. 20, 2017

(51) Int. Cl. H02G 3/08; F16M 13/02

(52) U.S. Cl. CPC H02G 3/08; F16M 13/02

(57) ABSTRACT

A device holder is provided, which may receive and securely hold multiple devices, for example, ballasts or power boxes, of any make, model, or size. The device holder may minimize property damage and mitigate fire and safety risks. The device holder may be modular, allowing a user to arrange any number of devices onto a surface.

### FIELD

This disclosure relates generally to a device holder.

### BACKGROUND

People often use multiple devices in a single location. Wires connecting the devices to a power source often become tangled or pulled, for example, creating significant fire and safety hazards. People also often mount multiple devices, for example, ballasts, directly onto a wall or other surface. A ballast limits an amount of current through an electrical load.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, a device holder, which may receive and securely hold multiple devices, for example, ballasts or power boxes, of any make, model, or size. In one embodiment, device holder may comprise a board having a plurality of tracks and clamps operable to hold devices securely in place. Device holder may reduce fire and safety hazards by providing an organized arrangement of devices, wires, or power sources. The marketplace lacks an organized, efficient, and safe way to mount multiple ballasts, or other devices, in a single location.

A person skilled in the art will understand that device holder and its components may comprise various shapes, colors, and sizes. Device holder may be made of polymers, composites, wood, rubber, metal, or other materials, for example.

Many of the attendant features may be more readily appreciated as they become better understood by reference to the following detailed description considered in connection with the attached drawings.

### BRIEF DESCRIPTION OF THE DRAWINGS

FIG. 1 illustrates a front view of a device holder, according to one embodiment.

FIG. 2 illustrates a front view of a device holder, according to one embodiment.

FIG. 3 illustrates a front view of a device holder, according to another embodiment.

Like reference numerals are used to designate like parts in the accompanying drawings.

### DETAILED DESCRIPTION

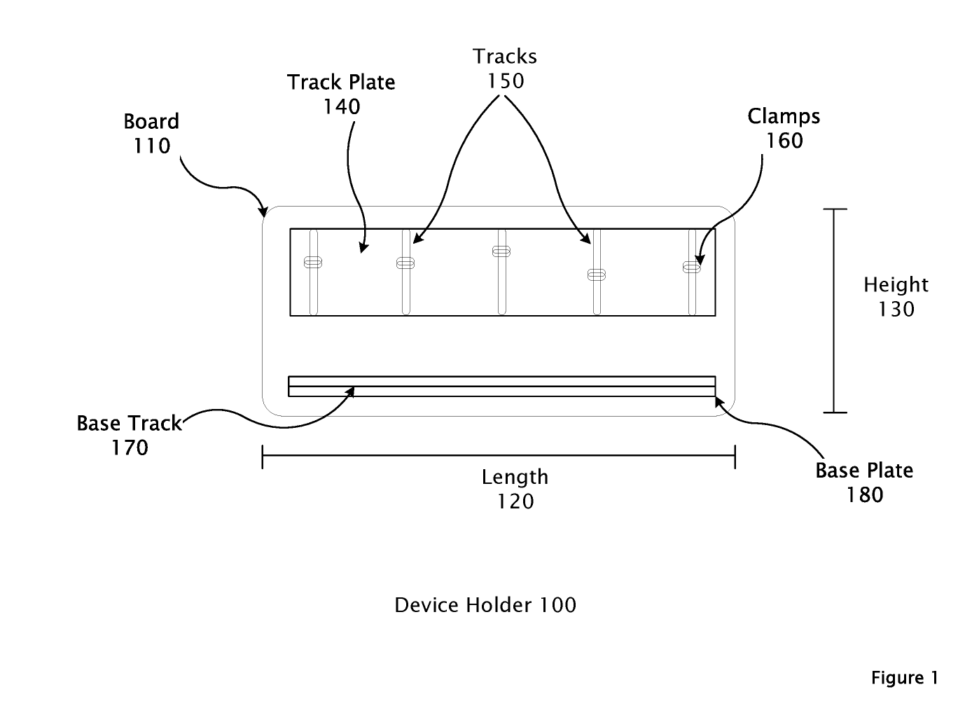

FIG. 1 illustrates a front view of Device Holder 100, according to one embodiment. Device Holder 100 may receive and securely hold multiple devices, for example, ballasts, of any make, model, or size. Device Holder 100 may comprise a Board 110 made of medium density fiberboard (MDF), which may have an outer shell made of Acrylonitrile butadiene styrene (ABS) plastic, for example. Board 110 may have Length 120 of approximately 46 inches, for example, and Height 130 of approximately 20 inches.

Track Plate 140 may be disposed on a surface of Board 110. Track Plate 140 may receive a plurality of Tracks 150. Tracks 150 may comprise elongated T-tracks made of anodized aluminum, for example, disposed adjacent to one another on Track Plate 140. Tracks 150 may be disposed vertically or horizontally, for example, on Track Plate 140.

Tracks 150 may receive Clamps 160. Clamps 160 may be operable to move along a length of Tracks 150. Clamps 160 may be loosened or tightened manually or automatically. Clamps 160 may comprise movable inline toggle clamps, push-pull clamps, or other fastening means.

In one embodiment, Clamps 160 may be operable to securely hold a device in place between Clamps 160 and Base Track 170 by compression, for example. Base Track 170 may comprise an elongated track extending along a length Base Plate 180, which may be disposed below or adjacent to Track Plate 140. Base Track 170 may be made of anodized aluminum or any other material.

Device Holder 100 may be mounted horizontally or vertically, for example, on a wall or other surface. Device Holder 100 may reduce damage to a device by eliminating a need to drill screws through the device, for example, through ballast flanges. Device Holder 100 may minimize property damage and improve aesthetics of a home or office space, for example, by reducing a number of holes drilled into a wall or other surface. Device Holder 100 may also reduce fire and safety hazards by providing an organized arrangement of ballasts, wires, or power sources.

A person skilled in the art will understand that Device Holder 100 and its components may comprise any shape, color, and size. Device Holder 100 may be made of any combination material, for example, polymers, composites, wood, rubber, or metal.

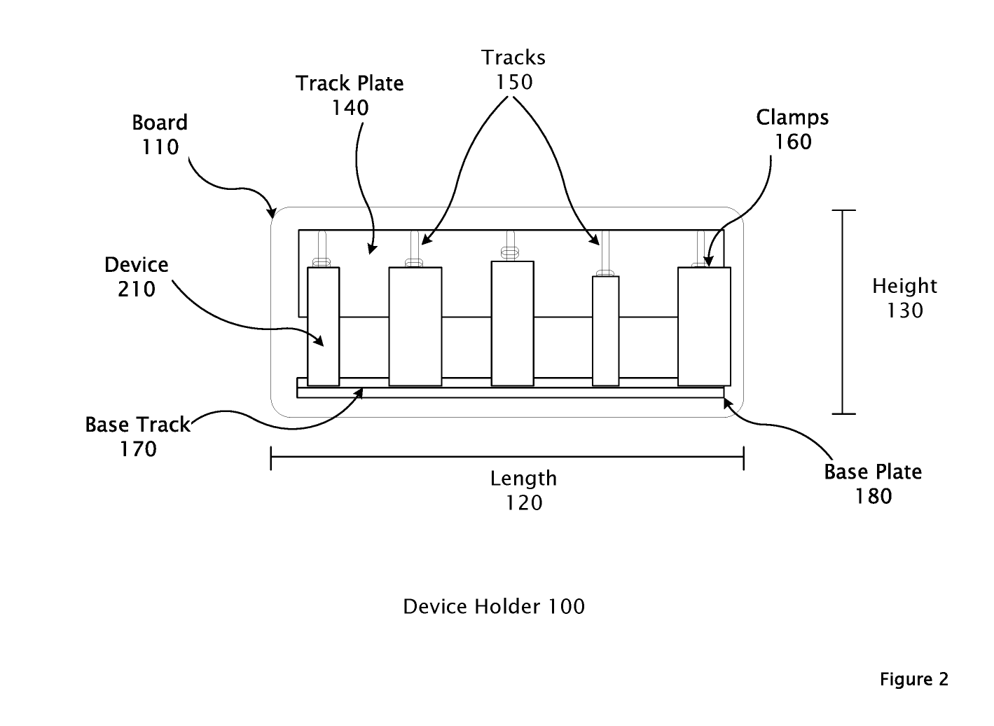

FIG. 2 illustrates a front view of a device holder, according to one embodiment. Device Holder 100 may comprise Board 110, which may be made of medium density fiberboard (MDF). Board 110 may have an outer shell made of Acrylonitrile butadiene styrene (ABS) plastic, for example. Board 110 may have Length 120 of approximately 46 inches, for example, and Height 130 of approximately 20 inches.

Track Plate 140 may be disposed on a surface of Board 110. Track Plate 140 may receive a plurality of Tracks 150. Tracks 150 may comprise elongated T-tracks made of anodized aluminum, for example, having a thickness of approximately ⅛ inch. Tracks 150 may each have a length of approximately 8 inches, for example, and may be oriented vertically or horizontally. In one embodiment, Tracks 150 may be disposed adjacent to one another on Track Plate 140.

One having skill in the art will recognize that Board 110 or other components may have different measurements depending on the number or size of devices they are configured to hold, or other factors.

Tracks 150 may receive Clamps 160, which may be operable to move along a length of Tracks 150. Clamps 160 may comprise movable inline toggle clamps, push-pull clamps, or other fastening means. In another embodiment, hooks, buckles, straps, snaps, clips, magnets, adhesives, or hook-and-loop fasteners, for example, may be used. Clamps 160 may be loosened or tightened manually or automatically. Clamps 160 may each be operable to receive and securely hold approximately 500 pounds, for example, or any weight load. Clamps 160 may be made of high tensile plastic or another material.

In one embodiment, Clamps 160 may be operable to securely hold a Device 210 in place between Clamps 160 and Base Track 170 by compression, for example. Base Track 170 may comprise an elongated track extending along a length Base Plate 180, which may be disposed below or adjacent to Track Plate 140. Base Track 170 may be made of anodized aluminum or any other material. Clamps 160 may hold Device 210 securely in place without impairing the functionality of Device 210 or causing damage to Device 210 or property.

In one embodiment, a user may place a first, downward-facing distal end of Device 210, for example, a ballast, on Base Track 170. The user may slide Clamp 160 downward along Track 150 until Clamp 160 comes into contact with a second, upward-facing distal end of Device 210. Clamp 160 may be tightened until Device 210 is held securely in place by compression between Clamp 160 and Base Track 170. Clamps 160 may be tightened by twisting a knob or another fastening means, or pushing a button, for example. Clamp 160 may have rubber stoppers at its base, for example, to prevent damage to a device and to hold the device securely into position. Clamp 160 may be loosened to release Device 210.

In another embodiment, Device Holder 100 may have a horizontal Clamp 160 with a quick snap and release feature, which may allow a user to push down a handle to lock Clamp 160 into place. This type of Clamp 160 may be handy for users who frequently need to switch out devices, for example.

In one embodiment, Device Holder 100 may provide approximately 7.5 inches of space between devices, for example, or any other distance. In another embodiment, Device Holder 100 may include a cooling device, for example, a fan. In yet another embodiment, Device Holder or its components may have apertures operable to release heat emitted from a device, or a heat shield to protect against heat damage. In yet another embodiment, Device Holder 100 may be modular, allowing a user to arrange any number of devices onto a surface.

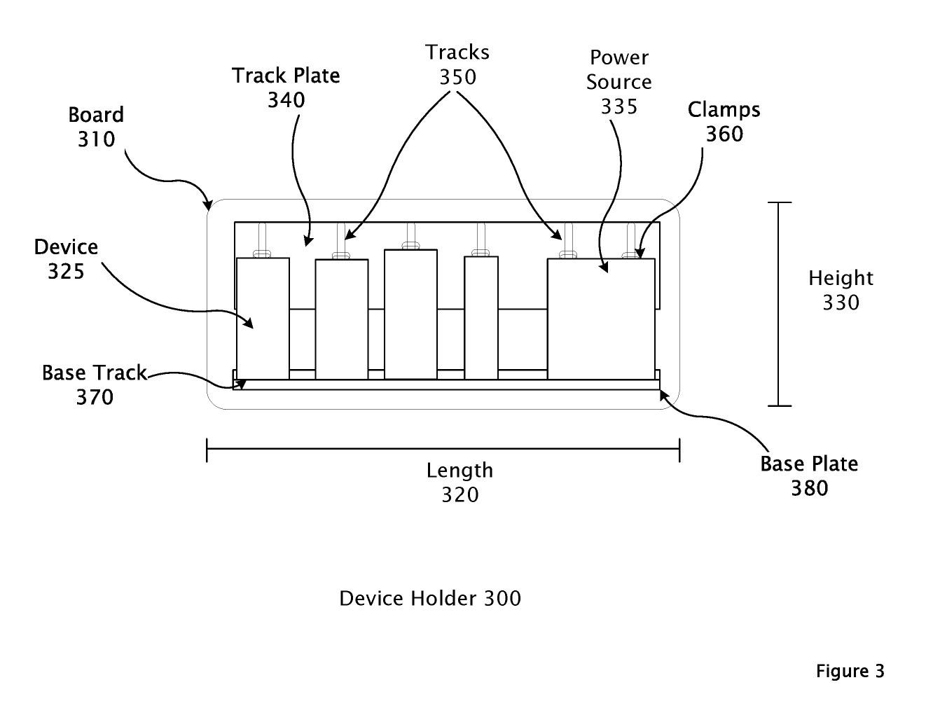

FIG. 3 illustrates a front view of a device holder, according to another embodiment. In this embodiment, Device Holder 300 may hold multiple Devices 325, for example, ballasts, and one or more Power Sources 335, for example, a power box. Board 310 may be made of medium density fiberboard (MDF), for example, having an outer shell made of Acrylonitrile butadiene styrene (ABS) plastic. Board 310 may have a thickness of approximately ⅜ inch, for example. Board 310 may have Length 320 of approximately 49 inches, for example, and Height 330 of approximately 20 inches.

Track Plate 340 may be disposed on a surface of Board 310. Track Plate 340 may receive a plurality of Tracks 350. Tracks 350 may comprise elongated T-tracks made of anodized aluminum, for example, having a thickness of approximately ⅛ inch.

Tracks 350 may each have a length of approximately 8 inches, for example. Tracks 350 may be oriented vertically or horizontally on Track Plate 340. Tracks 350 may receive Clamps 360. Clamps 360 may be operable to move along a length of Tracks 350. Clamps 360 may comprise movable inline toggle clamps, push-pull clamps, or other fastening means. In another embodiment, hooks, buckles, straps, snaps, clips, magnets, adhesives, or hook-and-loop fasteners may be used, for example. Clamps 360 may be loosened or tightened manually or automatically. Clamps 360 may each be operable to receive and securely hold approximately 500 pounds, for example, or any weight load. Clamps 360 may be made of high tensile plastic or another material.

One having skill in the art will recognize that Board 310 or other components may have different measurements depending on the number or size of devices they are configured to hold, or other factors.

In one embodiment, Clamps 160 may be operable to securely hold Device 325 or Power Source 335 in place between Clamps 360 and Base Track 370 by compression, for example. Base Track 370 may comprise an elongated track extending along a length Base Plate 380, which may be disposed below or adjacent to Track Plate 340. Base Track 370 may be made of anodized aluminum or any other material. Clamps 360 may hold Device 325 or Power Source 335 securely in place without impairing the functionality of Device 325 or Power Source 335 or causing damage to Device 325, Power Source 335, or other property. In one embodiment, Device Holder 100 may have pre-cut holes operable to receive wires and cords, or grooves in which cords may be snapped into place, for example.

1. A device holder, comprising:
a board;
a first plate, the first plate coupled to the board;
a plurality of tracks, the tracks disposed on the first plate;
a plurality of clamps, the clamps coupled to the plurality of tracks and operable to move along lengths of the tracks;
a second plate, the second plate coupled to the board;
a base track, the base track extending along a length of the second plate; and
a plurality of fastening means coupled to the second plate.

2. The device holder of claim 1, wherein the device holder or its components are made of material selected from the list containing composites, medium density fiberboard (MDF), wood, polymers, Acrylonitrile butadiene styrene (ABS) plastic, rubber, metal, and anodized aluminum.

3-5. (canceled)

6. The device holder of claim 1, wherein the fastening means is selected from the list containing inline toggle clamps, push-pull clamps, hooks, buckles, straps, snaps, clips, magnets, adhesives, and hook-and-loop fasteners.

7. The device holder of claim 1, wherein the clamps are selected from the list consisting of moveable inline toggle clamps and push-pull clamps.

8. The device holder of claim 1, wherein the clamps are operable to hold a device in place.
